(19) United States
(12) Patent Application Publication
(10) Pub. No.: US 2016/0039700 A1
(43) Pub. Date: Feb. 11, 2016

(54) FERMENTATION RESIDUE CONDITIONER AND METHOD FOR CONDITIONING FERMENTATION RESIDUES

(71) Applicant: KOMPOFERM GmbH, Marienfeld (DE)

(72) Inventor: Karlgünter Eggersmann, Marienfeld (DE)

(73) Assignee: KOMPOFERM GmbH, Marienfeld (DE)

(21) Appl. No.: 14/755,356

(22) Filed: Jun. 30, 2015

(30) Foreign Application Priority Data
Aug. 11, 2014 (EP) 14002791.3

(51) Int. Cl. C02F 11/12; F26B 17/02; F26B 17/04; F26B 3/20

(52) U.S. Cl. CPC C02F 11/12; F26B 3/20; F26B 17/023; F26B 17/045

(57) ABSTRACT

Fermentation residue conditioner 1 for conditioning aggregate materials 3 consisting of fermentation residue, sludge, and/or organic residual masses with high water content, particularly of fermentation residues from the fermentation of household waste, bio-waste and/or base materials containing food residues, having a fermentation residue dropping point 4 for introducing the aggregate material 3 and a fermentation residue removal point 5 for removing the aggregate material 3. The fermentation residue conditioner 1 is designed such that the aggregate material 3 is transportable through the fermentation residue conditioner 1 during conditioning. The fermentation residue conditioner 1 has a deposit surface 2 for supporting the aggregate material 3 from the underside, and which is designed such that the transport of the aggregate material 3 can be effected by said deposit surface 2.

### CROSS REFERENCE TO RELATED APPLICATIONS

This application claims the benefit of and priority on European Patent Application No. 14002791.3 having a filing date of 11 Aug. 2014.

### BACKGROUND OF THE INVENTION

1. Technical Field

The method relates to a fermentation residue conditioner and a method for conditioning fermentation residues or sludge and/or organic residual masses with high water content, particularly from the fermentation of household waste, bio-waste and/or base materials containing food residues.

2. Prior Art

Fermentation residues and sludge accumulate, for example, in plants for producing biogas or sewage plants and, for their further treatment, e.g. by composting, have an unfavorable consistency, among others, an excessive moisture content. This applies particularly to household waste, bio-waste, and/or base materials containing food residues. They have a very high energy content which makes them appear to be suitable for further processing, for example with fermentation processes with anaerobic fermentation and subsequent follow-up treatment, for example, subsequent composting. However, the consistency and the high moisture content of such base materials is disadvantageous.

For further processing, structural material that forms air pores and absorbs moisture, e.g. the screen overflow of composting, particularly bio-waste composting, and/or shredded organic waste, is frequently added to such base materials. The mixture of these materials is very frequently heterogeneous which prevents consistent ventilation.

In addition, such base materials, particularly household waste, bio-waste, and/or base materials having screening residues as structural material, contain impurities, for example, plastic films from garbage bags and/or meshes which should not find their way into the finished materials, for example, the compost or the deposit.

For these reasons, such base materials are conditioned for further processing, i.e. in particular, the moisture content is lowered, ammonia and/or methane are expelled, clumps are dissipated, and/or the base materials are homogenized.

### BRIEF SUMMARY OF THE INVENTION

Therefore, the invention addresses the problem of providing a fermentation residue conditioner for processing such base materials and a method for conditioning said base materials which both allow for an efficient conditioning of the fermentation residues while reducing the release of emissions.

The problem is solved by a fermentation residue conditioner and a method for conditioning fermentation residues or sludge according to the independent claims. The dependent claims relate to advantageous embodiments.

In the following, only the term “fermentation residues” will be used for the terms “fermentation residues” and “sludge” as well as for “organic residual masses with high water content, particularly fermentation residues from the fermentation of household waste, screening residues, and/or base materials containing food residues.”

This also applies to the claims and serves as linguistic simplification.

The fermentation residue conditioner according to the invention comprises a deposit surface for fermentation residues which preferably extends in a first extension direction. The fermentation residues can be piled up on said deposit surface as aggregate material. The fermentation residue conditioner further comprises a fermentation residue dropping point and a fermentation residue removal point which is preferably spaced apart from the fermentation residue dropping point along the first extension direction. At first, fermentation residue dropping point and fermentation residue removal point only denote the spatially determined regions in which the fermentation residues are dropped onto and removed from the fermentation residue conditioner. A specific design of these points can be advantageous but is basically not required. Therefore, fermentation residue dropping point and fermentation residue removal point do not necessarily have to differ structurally from the rest of the fermentation residue conditioner, particularly from other sections of the fermentation residue conditioner along the first extension direction.

According to the invention, transport can be effected by a deposit surface for support from the underside of the aggregate material, i.e. the forces required for the transport of the fermentation residue are introduced in the underside of the aggregate material which is formed by the fermentation residue.

The aggregate material is to be understood to be aggregate material in the broadest sense; in particular, the term also includes very wet materials, such as sludge, i.e. materials from compact to porous consistency as well as very heterogeneous materials, particularly with clumps and/or regions discreetly separated by planar formations, for example regions encased or separated from one another by plastic films which, for example, are caused by garbage bags. For the sake of linguistic simplicity, in the following, the spatial arrangements of the aforementioned base materials in the fermentation residue conditioner according to the invention and for the execution of the method according to the invention will be generally called aggregate materials, even if they have a consistency which is not typical for aggregate material in the narrower sense of the word. This also applies to the use of the term aggregate material in the claims.

The application of force from the underside onto the aggregate material allows for it to be transported through the fermentation residue conditioner, whereby the inner structure of said aggregate material is not crucial. As a result, the most diverse materials can be transported without problem. Furthermore, the transport does not depend on a possible shifting or homogenization, i.e. it is possible to provide appropriate means for shifting or homogenizing the aggregate material and to adjust said means to the aggregate material such that the shifting is effected with regard to the protection of plastic films and similar impurities. This prevents said impurities from being shredded and allocated to the incorrect fraction during subsequent separation processes or from not being separated at all. In this regard, the application of force from the underside is also particularly advantageous because it is not accompanied by a penetration of the aggregate material itself and thus is also protective of material with regard to the shredding of possible impurities.

Preferably, the deposit surface has back-and-forth movable deposit elements for supporting the aggregate material. They are particularly designed such that a closed, preferably also liquid-tight deposit surface for the aggregate material is always formed. A plurality of deposit surfaces is provided particularly in the direction perpendicular to the transport direction and/or perpendicular to the direction of movement of the deposit elements. If these deposit elements are suitably controlled in their movement, the deposit elements can effect a transport of the aggregate material deposited on the deposit elements by their back and forth movement, for example, by moving the deposit elements individually in the opposite direction of the transport direction and then together in transport direction, and so the aggregate material deposited on the deposit elements substantially only follows the movement in transport direction. Correspondingly, it is also possible for the deposit elements to be moved in groups as long as the desired transport effect is achieved. Such a design of the deposit surface is routinely called “walking floor.”

A further advantageous design option provides for a transport element which is movable relative to the floor surface. This, for example, can be a thin wire comb. It has become apparent that, if such a transport element is designed to be sufficiently flat, it also only allows for the introduction of the movement force on the underside of the aggregate material in accordance with the invention. It has become apparent that the desired effect, i.e. introduction of the force causing the movement, can be achieved with such movable transport elements without noticeably disadvantageous penetration of the aggregate material if the part of the transport elements which directly causes the transport does not protrude into the aggregate material by more than 40 mm, preferably 15 mm from the deposit surface. The part which does not directly cause the transport is the part of a movable transport element which applies force directly to the underside of the aggregate material at an appropriate time point. It is understood that, for example within the course of the return of a rotating movable transport element, said transport element, for example, can be guided back on the ends of the fermentation residue conditioner upward or downward out of and over and below the fermentation residue conditioner in order to create a continuous loop similar to a conveyor belt. It is understood that such a part of the transport element which is guided away from the deposit surface is not to be considered to be a part of the movable transport element which directly effects transport.

According to a further advantageous embodiment, the deposit surface can also be designed along the lines of a belt conveyor. Such a belt conveyor preferably has planar deposit elements, which are preferably arranged next to one another in transport direction, and which form movable deposit surfaces for the aggregate material. The deposit elements are preferably arranged so as to be oriented with their greatest extension direction in transport direction.

Preferably, the deposit elements which form the deposit surface, or the deposit surface, are made of metal which has an advantageous effect on an advantageous heating of the aggregate material from the underside since metal has good conductivity for heat.

The fermentation residue conditioner according to the invention is preferably designed so as to be heat-insulated for optimizing the thermal efficiency due to heat losses to the atmosphere and thus recondensation.

The fermentation residue conditioner furthermore preferably has a shifting and decompacting unit. This shifting and decompacting unit is suitable and designed to shift and homogenize the fermentation residues located on the deposit surface when used as intended, break up clumps, form new surfaces, cause a mixing of the fermentation residue and/or support the transport of the fermentation residue along the first extension direction.

Preferably, the method according to the invention provides for the aggregate material to be deposited on a fermentation residue conditioner in the region of the fermentation residue dropping point, and the aggregate material is removed from the fermentation residue conditioner in the region of the fermentation residue removal point which is spaced apart from the fermentation residue dropping point along the first extension direction of a deposit surface for the aggregate material of the fermentation residue conditioner, wherein the aggregate material is transported from the fermentation residue dropping point to the fermentation residue removal point along the first extension direction across the deposit surface. It is advantageous if the shifting and decompacting unit acts on the fermentation residues simultaneously only on a partial section of the entire extension of the deposit surface along the first extension direction between fermentation residue dropping point and fermentation residue removal point. This way, the shifting and decompacting unit, which only extends over a partial section of the aforementioned entire extension, can be designed so as to be structurally smaller, thus saving more material and costs than a shifting and decompacting unit which would act on the entire amount of fermentation residue and would thus have to extend over the entire deposit surface.

This advantageous measure is based on the realization that, with regard to the conditioning process, it suffices if only a part of the fermentation residues is simultaneously shifted at a time because the drying processes in particular take up a certain amount of time. Multiple shifting, which is used to homogenize the fermentation residue mass and particularly to break up clumps, only requires a fraction of the time needed for the entire conditioning process.

This is made possible particularly by a shifting and decompacting unit which has a rotating shifting body. By means of this shifting body, which preferably rotates around an axis which is horizontal and/or runs at a right angle to the first extension direction, the shifting and decompacting unit acts on the fermentation residues. The shifting body can cause a shifting but also support the transport by the fermentation residue conditioner, wherein it is particularly advantageous if the rotational direction of the shifting body is selected such that its upper apex moves in the direction of the fermentation residue removal point. Furthermore, due to this shifting during multiple shiftings, a fermentation residue clump is gradually broken up such that the outer already dried material falls off and the still wet material below is dried further, wherein said process is repeated. In addition, clumps are split, and so larger surfaces are provided for drying. An apex is also understood to be an apex line which forms particularly with a shifting body designed so as to be cylindrical.

In order to make it possible that the shifting and decompacting unit can act, if not simultaneously then at least time-delayed, on all regions of the aggregate material on the deposit surface, it is advantageous if the shifting and decompacting unit is movable along the first extension direction.

For example, this can be achieved with guides, e.g. a rail system, extending along the first extension direction. The guides are located advantageously above the aggregate material height resulting from the intended use of the fermentation residue conditioner and/or outside the fermentation residue conditioner. It is thus ensured that the function of the guides for the shifting and decompacting unit is not affected by fermentation residues.

It is advantageous to execute the method such that it results in an aggregate material height of the aggregate material from 10 to 100 cm, particularly from 20 to 40 cm. This aggregate material height results in a drying speed at which the advantages of the present invention can be used efficiently.

It is meaningful to accommodate the shifting and decompacting unit on the fermentation residue conditioner, preferably on the guides, by means of a distance adjustment unit. The distance adjustment unit is used to change the distance of the shifting and decompacting unit to the deposit surface and can, for example, be realized by means of a swivel element. This way, the shifting and decompacting unit can move upward and avoid hard objects which are possibly located under the fermentation residues, thus effectively preventing damage to the shifting and decompacting unit and the deposit surface by the hard objects when they get between the shifting and decompacting unit and the deposit surface, and making the return travel possible.

It is furthermore advantageous if the deposit surface has a heating unit which makes a direct heat transfer to the aggregate material possible by heat conduction. By means of the heating unit, it is possible to heat the aggregate material which accelerates the drying of the aggregate material. The interaction of a heated deposit surface with a shifting and decompacting unit is particularly advantageous because with every shifting, a new surface of the fermentation residues comes in contact with the heated deposit surface, thus resulting overall in a homogeneous and accelerated drying process.

It is further advantageous if the deposit surface has a ventilation unit for ventilating the aggregate material. Ventilating the aggregate material ensures a faster moisture transport and also heat influx into the aggregate material, particularly with preheated air. It is particularly advantageous that clumps, so-called microbatches, are broken up through homogenization, and so the ventilation can also reach the moisture stored within these clumps and does not flow around said clumps.

The ventilation unit and/or the heating unit is segmented preferably along the first extension direction. In other words, a ventilation unit and/or a heating unit are each associated with individual sections of the first extension direction of the fermentation residue conditioner. It is also possible to provide a heating unit and/or a ventilation unit with a plurality of redundant elements, for example a plurality of supply or return and/or supply air or exhaust air lines or circuits, wherein the redundant elements are each associated with individual sections along the longitudinal extension of the fermentation residue conditioner.

Preferably, a system consisting of a plurality of fermentation residue conditioners is provided. The plurality of fermentation residue conditioners can be parallel- and/or series-connected. Preferred is a variation in which a plurality of fermentation residue conditioners, for reasons of installation space, is arranged spatially one above the other.

The described fermentation residue conditioner not only offers the possibility of drying fermentation residues thermally but particularly constitutes a preliminary stage for an optimized start of a subsequent aerobic treatment of the fermentation residues.

By means of the described fermentation residue conditioner, ammonia, which is present in the fermentation residues and toxic for an aerobic process, is effectively expelled and securely contained by means of preheated air. For securely containing the exhaust air and/or reduction of emissions, the fermentation residue conditioner is preferably designed such that gaseous emissions are prevented and/or at least avoided to a great extent. In particular, the fermentation residue conditioner is designed so as to be encapsulated. The concentrated exhaust air flows can be fed to an appropriate exhaust air treatment, e.g. an acid washer.

The treatment of the fermentation residues by means of the described fermentation residue conditioner releases methane contained in the fermentation residues through the airflow. Particularly with regard to the possibility of expelling ammonia and/or methane from the fermentation residue, it is advantageous if the fermentation residue conditioner is designed such that it is possible to guide the air for ventilating the fermentation residues at least to some extent in the circuit. It is preferably possible to control the ratio of the air guided in the circuit to the supplied and/or discharged air. This way, it is possible to increase the heat influx and/or the loading of the discharged air with ammonia and/or methane. This is advantageous because with a downstream exhaust air treatment, a smaller air volume has to be treated. It is particularly advantageous if the control range of the ratio covers the borderline cases of clean circulation and/or clean fresh-air ventilation.

In addition, due to the mechanical components of the described fermentation residue conditioner (loosening, macerating, and/or homogenizing), a forming of methane within the fermentation residue clumps or the like is significantly reduced or prevented and the release of climate-relevant methane into the atmosphere in downstream processes is significantly reduced.

With an optimized systemization/control of the shifting and decompacting unit, it is possible to adjust volume and dumping height losses of the fermentation residue due to, e.g. the reduction of organic mass and/or increased fine-grain formation through processing. In addition to adjusting the dumping height of the fermentation residues, the dumping height during treatment and thus the dwell time of the fermentation residues within the fermentation residue conditioner can further be increased. This results in a reduction of investment and thus treatment costs.

### BRIEF DESCRIPTION OF THE DRAWINGS

In the following, the invention is described in more detail using FIGS. 1 to 5.

FIG. 1 shows a schematic depiction of an exemplary fermentation residue conditioner according to the invention;

FIG. 2 shows a cross-section of an exemplary fermentation residue conditioner according to the invention with sectional plane running at a right angle to the transport direction;

FIG. 3 shows an exemplary fermentation residue conditioner according to the invention according to a further embodiment, also in schematic depiction, with the sectional plane perpendicular to the transport direction;

FIG. 4 shows a detailed depiction of a deposit surface of an exemplary fermentation residue conditioner according to the invention; and

FIG. 5 shows detailed depictions of individual deposit elements of an exemplary fermentation residue conditioner according to the invention

### DETAILED DESCRIPTION OF PREFERRED EMBODIMENTS

The exemplary fermentation residue conditioner 1 according to the invention has a deposit surface 2 for the aggregate material 3. The fermentation residues form the aggregate material 3 on the deposit surface 2 and are deposited at the fermentation residue dropping point 4, e.g. by a conveyor, onto the deposit surface 2.

The transport of the aggregate material 3 to the fermentation residue removal point 5 according to the invention is effected by the design of the deposit surface 2. In the depicted example, said deposit surface 2 has back-and-forth movable deposit elements 15 and 16, each associated with a drive element, for example a hydraulic 17, for moving the deposit elements 15 and 16 back and forth.

The shifting and decompacting unit 6, which is preferably accommodated along a rail system 8 which is arranged above the aggregate material height of the fermentation residues and/or outside of the fermentation residue conditioner, can, by means of a shifting body 7 which rotates in rotation direction R, act onto the fermentation residues which are thus shifted, loosened, and broken up.

The shifting body 7 is designed as a roll which rotates around the axis Y, having protrusions 7a, providing the roll with a profiling, with which it can favorably engage the fermentation residues 3 and homogenize, break up, and loosen said fermentation residues 3 and thus dry them faster.

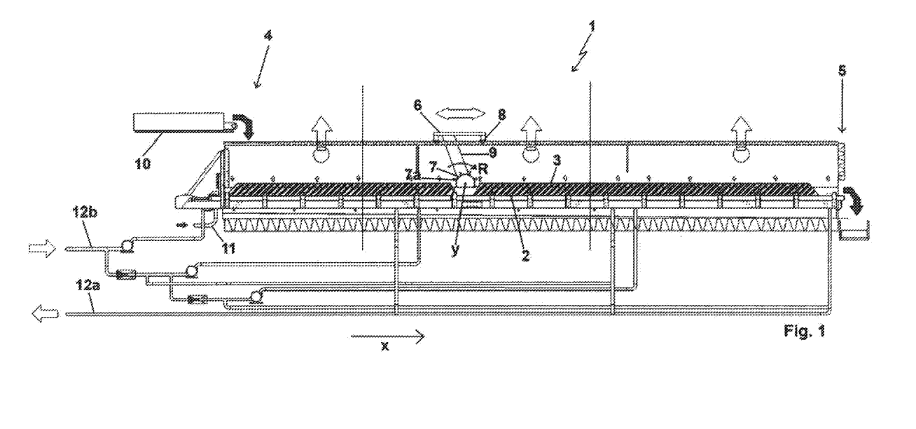

The floor of the fermentation residue conditioner 1 preferably has a heating unit 12 and/or a ventilation unit 11 below the deposit surface 2. The heating unit 12 has channels through which a heating medium can flow and which run horizontally below the deposit surface 2. The channels are each connected to a supply line 12b and a return line 12a for the heating medium, which are supplied with heating medium by means of a common return line, wherein the heating medium can also be discharged again by means of a common return line. Of course, a plurality of heating circuits with a corresponding plurality of supply lines or return lines can also be provided. In the depicted example in FIG. 1, three such heating circuits are associated with individual sections along the first extension direction X of the fermentation residue conditioner 1.

In the depicted example, the deposit elements 16 advantageously form the channels through which the heating medium flows.

The fermentation residue conditioner according to the invention can advantageously also have a ventilation unit 11. In the depicted example, it is realized such that the deposit elements 15 are provided with air outlet openings 18 and supplied with supply air by means of the ventilation unit 11, said supply air flowing out of the air outlet openings 18 and entering the aggregate material.

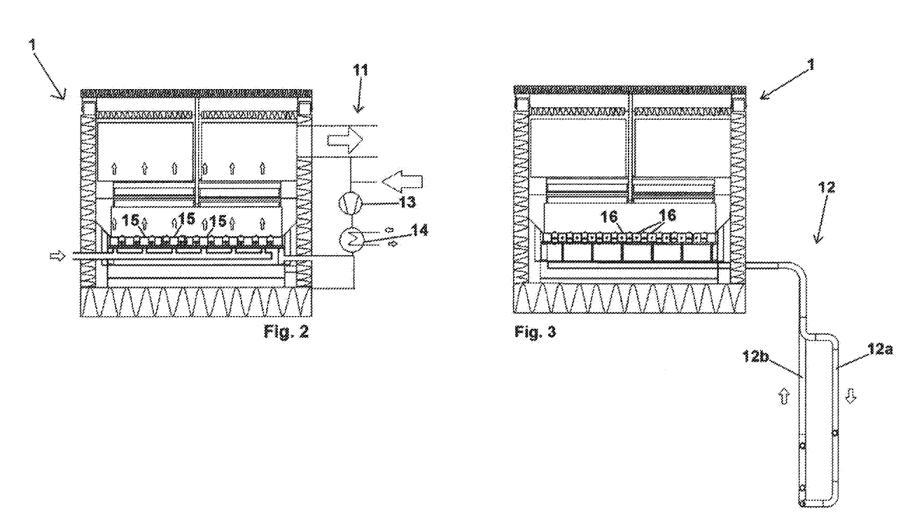

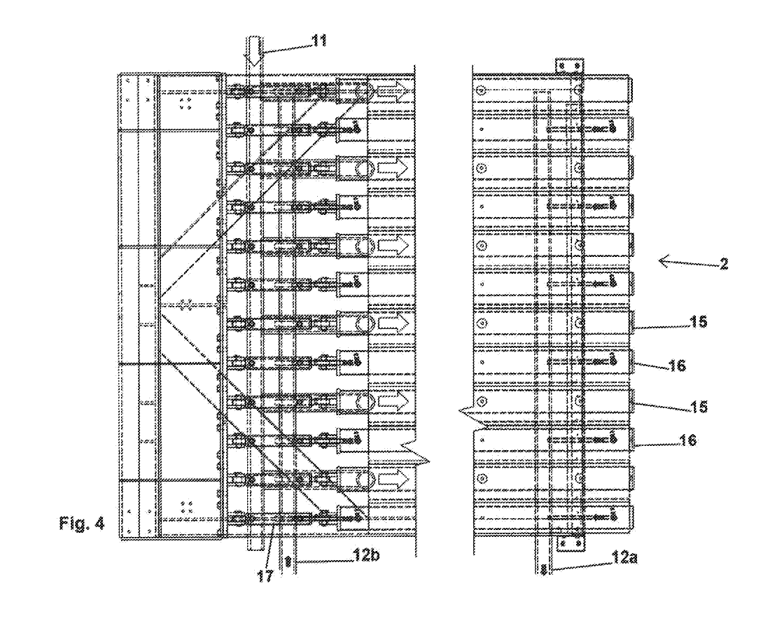

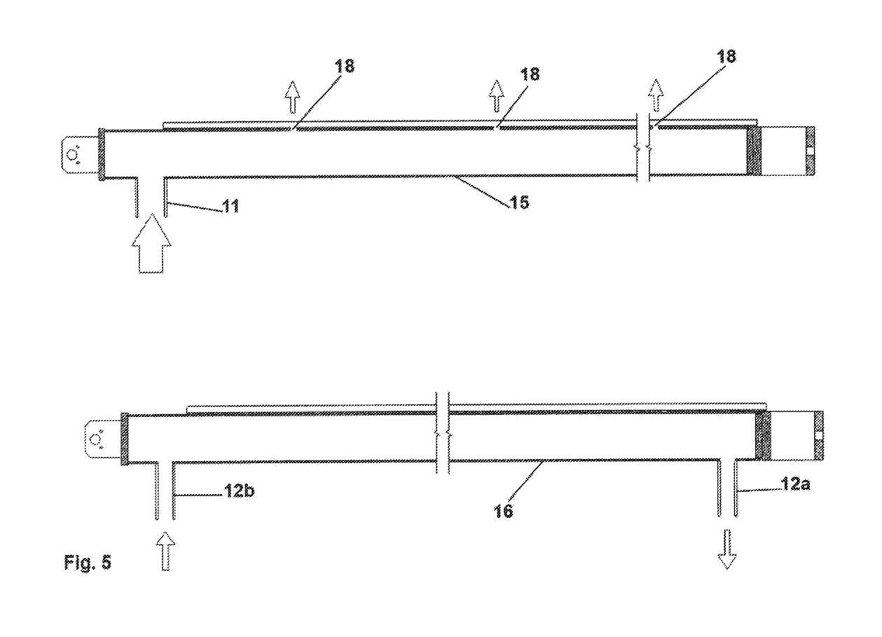

FIG. 2 shows a corresponding ventilation unit 11. In width direction of the exemplarily depicted fermentation residue conditioner, every other deposit element 15 is supplied by the ventilation unit 11. FIG. 3 shows the cross-section of an exemplary fermentation residue conditioner according to the invention, in which every other deposit element 16 is supplied with a heating medium by a heating unit 12. Of course, it is also possible and particularly advantageous if a single fermentation residue conditioner according to the invention has deposit elements 15 which are supplied with air by means of a ventilation unit 11 and deposit elements 16 which are supplied with a heating medium by a heating unit 12. As a result, they can alternate, advantageously individually or in groups, in width direction of the fermentation residue conditioner according to the invention, i.e. perpendicular to the transport direction X of the fermentation residue conditioner.

In the depicted example, the air is transported by a transport unit 13, for example a compressor. In the depicted example, the ventilation unit 11 is designed such that some of the air can be guided in the circuit. The transport unit 13 can be supplied with a mixture with any ratio of supply air and exhaust air which are extracted from the fermentation residue conditioner 1.

Furthermore, an additional heating unit 14 is provided for the air to be supplied which is advantageous because, by means of the air, additional heat can be introduced to the aggregate material of the fermentation residues 3. In addition, the warm air can absorb and discharge a greater quantity of moisture from the fermentation residues. Particularly in case of fermentation residue and sludge, ammonia contained therein is securely expelled by means of the described measures. Furthermore, due to the breaking up of fermentation residue clumps, possible occurring fermentation processes or anaerobic processes which produce methane can be securely terminated.

What is claimed is:

1. A fermentation residue conditioner (1) for conditioning aggregate materials (3) consisting of fermentation residue, sludge, and/or organic residual masses with high water content, particularly of fermentation residues from the fermentation of household waste, bio-waste and/or base materials containing food residues, with a fermentation residue dropping point (4) for introducing the aggregate material (3) and a fermentation residue removal point (5) for removing the aggregate material (3), wherein the fermentation residue conditioner (1) is designed such that the aggregate material (3) is transportable through the fermentation residue conditioner (1) during conditioning, the fermentation residue conditioner (1) comprising:
a ventilation unit (11);
a heating unit (12); and
a deposit surface (2) for supporting the aggregate material (3) from the underside,
wherein the deposit surface (2) is designed such that the transport of the aggregate material (3) can be effected by said deposit surface (2).

2. The fermentation residue conditioner (1) according to claim 1, wherein the deposit surface (2) comprises deposit elements (15, 16), movable back and forth in transport direction, for supporting the aggregate material (3), and is particularly designed so as to be a walking floor.

3. The fermentation residue conditioner (1) according to claim 1, wherein the deposit surface (2) comprises a transport element, particularly a wire comb, which is movable relative to the deposit surface (2) and which, for transporting the aggregate material, is movable relative to the floor surface and is designed such that the parts which directly cause the transport do not protrude into the aggregate material (3) by more than 40 mm, preferably by no more than 15 mm from the deposit surface (2).

4. The fermentation residue conditioner (1) according to claim 1, wherein the deposit surface (2) is designed along the lines of a belt conveyor, particularly with continuous planar deposit elements, wherein deposit elements are preferably oriented with their greatest extension direction in transport direction (X).

5. The fermentation residue conditioner (1) according to claim 1, wherein the fermentation residue conditioner has a shifting and decompacting unit (6) for shifting, loosening, macerating, and/or homogenizing of an aggregate material located on the deposit surface (2).

6. The fermentation residue conditioner (1) according to claim 5, wherein the shifting and decompacting unit (6) has a rotating shifting body (7) which preferably rotates around an axis (Y) which is horizontal and/or runs at a right angle to a first extension direction (X).

7. The fermentation residue conditioner (1) according to claim 6, wherein the shifting and decompacting unit (6), particularly the shifting body (7), only extends over a partial section of the entire extension of the deposit surface along the first extension direction (X) between fermentation residue dropping point (4) and fermentation residue removal point (5).

8. The fermentation residue conditioner (1) according to claim 5, wherein the shifting and decompacting unit (6) is movable along a first extension direction (X).

9. The fermentation residue conditioner (1) according to claim 1, wherein the deposit surface (2) has the preferably planar and/or segmented heating unit (12) and/or a heat insulation.

10. The fermentation residue conditioner (1) according to claim 1, wherein the deposit surface (2) has the preferably planar and/or segmented ventilation unit (11) for ventilating the aggregate material preferably with warm air and or partial circulating air guide.

11. A method for conditioning a fermentation residue, wherein the fermentation residue is transported as aggregate material (3), supported from the underside, by a fermentation residue conditioner, particularly by a fermentation residue conditioner (1), and the fermentation residue is conditioned during transport for a subsequent, particularly aerobic treatment, comprising transporting the aggregate material (3) by forces introduced to the underside of the aggregate material (3).

12. The method according to claim 11, further comprising feeding heat, preferably by heat conduction, during transport to the aggregate material (3), particularly to the underside of the aggregate material (3).

13. The method according to claim 11, further comprising ventilating the aggregate material (3), particularly from the underside of the aggregate material (3), during transport with preferably preheated and/or circuit-guided air.

14. The method according to claim 11, wherein the aggregate material (3) is shifted, loosened, macerated, and/or homogenized during transport.
